(19) United States
(12) Patent Application Publication
(10) Pub. No.: US 2002/0008187 A1
(43) Pub. Date: Jan. 24, 2002

(54) Moveable machine foot with sealing function

(76) Inventor: Bernhard Ganter, Kirnerstrasse (DE)

Correspondence Address: DARBY & DARBY P.C., 805 Third Avenue, New York, NY, 10022, US

(21) Appl. No.: 09/899,759

(22) Filed: Jul. 5, 2001

(30) Foreign Application Priority Data
Jul. 7, 2000 (DE) 100 33 226.9

(51) Int. Cl. F16M 1/00; F16M 11/00; F16M 3/00

(52) U.S. Cl. 248/677; 248/650

(57) ABSTRACT

The invention is directed to a moveable machine foot providing a sealing function between a threaded spindle and a corresponding support plate of the machine foot. Bacteria can be trapped between these two elements, in particular when liquids come in contact with the threaded spindle, drip downwardly and come close to the gap, since these liquids can then fill the gap, with residual contamination being formed in the adjustment range between the threaded spindle and the support plate located next to the floor. It is therefore an object of the invention to prevent the incursion of liquids between these two elements.

### BACKGROUND OF THE INVENTION

The subject matter of the invention relates to a moveable machine foot incorporating a sealing function. The machine foot incorporates at least one element of an adjustable length, such as a threaded spindle, with an adjustable support element disposed thereon, for supporting the threaded spindle. Machine feet of this type are used for supporting machines in relation to a floor and are adjustable in height. Machine feet of this type can also be used for lateral support.

### DESCRIPTION OF THE RELATED ART

Conventional machine feet have a disadvantage of not being able to comply with strict hygienic requirements, since the required clearance for the adjustment results in a gap between the threaded spindle and the support plate located near the floor which can pose a health risk.

This gap can trap bacteria, in particular when liquids come into contact with or drip on the threaded spindle and come close to the gap. The gap can entrain the liquids, forming a residual contamination in the adjustment region between the threaded spindle and the support plate located next to the floor.

### SUMMARY OF THE INVENTION

It is therefore an object of the invention to provide a machine foot with a sealing function, wherein the adjustment gap between the adjustable threaded spindle and the moveable support plate is sealed.

Accordingly, a threaded spindle is provided which has an annular collar on the side facing the support plate, with the outer diameter of the annular collar having a large enough size so that the annular collar covers and seals against the connecting collar of the support plate even in the event that the center axes of the two units are not mutually parallel, but are tilted at an angle.

According to one aspect of the invention, it is an important feature of the invention that the lower end of the threaded spindle located next to the floor has a radially outwardly extending annular shoulder, which overlaps with a corresponding connecting collar disposed on the support foot, wherein the connecting collar has an outer convex curvature.

Further, a type of a ball connection (a ball engaging in a ball socket) between this threaded spindle and the support foot located next to the floor is formed, wherein the two spherical surfaces overlap, thereby preventing liquids that drip downwardly from the threaded spindle from entering the gap.

Because the gap is formed by the two spherical surfaces, the liquid cannot enter the interior space of the support plate.

Thus, it is important that the end face of the threaded spindle located near the floor has a concave shape and, conversely, the associated opposite surface on the support foot has a convex shape, and that these two parts slide by and engage with one another, thereby eliminating the outwardly extending sealing gap.

Liquids that drips downwardly from the threaded spindle therefore run off the mutually engaging spherical surfaces and do no longer enter the connecting region between the threaded spindle and the support foot.

It will be understood, that the invention is not limited to two mutually engaging spherical surfaces, but that other engaging and overlapping surfaces can be used instead of spherical surfaces. For example, a spherical surface can be mated with a corresponding conical surface, with one surface being disposed on the threaded spindle and the other surface on the support plate, or vice versa.

It is only important that the two surfaces overlap one another in order to eliminate an outwardly extending in gap which could cause liquids that drip downwardly to enter the gap and thereby reach the interior space of the support foot.

Advantageously, these measures make it possible to eliminate additional sealing means. Because these metal surfaces overlap, the connection can withstand a high load. A machine foot may have to support a load of several tons, which is facilitated by the metal surfaces of the engaging spherical or conical surfaces.

As also illustrated, interposed sealing rings, O-rings or elastomer sleeves also become unnecessary.

It will be understood that the invention is not limited to this particular embodiment and that additional sealing means may be employed in addition to the aforedescribed overlapping sealing surfaces.

Not only can two spherical surfaces or a spherical and a conical surface mate, but as a third possibility, two corresponding conical surfaces can also overlap and form a sealing gap.

According to an additional, separate feature of the invention, only a single elastomer sealing means may be employed, thereby eliminating the aforedescribed spherical or conical surfaces. Such elastomer sealing means can be, for example, an elastomer sealing apron. In this case, the upper annular collar of the sealing apron contacts the threaded spindle, whereas the radially outwardly extending surfaces of the sealing apron overlap the sealing gap, with corresponding sealing lips sealingly contacting the surface of the support plate. An elastomer sealing apron of this type is also part of the claimed subject matter of the present invention, in addition to the aforedescribed features which include the superpositioned spherical or conical surfaces.

The subject matter of the present invention is not limited by the features recited in the individual claims, but also in a combination of the claims.

All features disclosed in the specification, including the summary, in particular the embodiments illustrated in the drawings, are claimed as part of the invention, as far as they are novel, either alone or in combination, in view of the state of the art.

Other objects and features of the present invention will become apparent from the following detailed description considered in conjunction with the accompanying drawings. It is to be understood, however, that the drawings are intended solely for purposes of illustration and not as a definition of the limits of the invention, for which reference should be made to the appended claims.

In the following, several embodiments of the invention will be described in detail with reference to the drawings. Additional features and advantages of the invention are also evident from the drawings and their description.

### BRIEF DESCRIPTION OF THE DRAWINGS

In the drawings, wherein like reference numerals delineate similar elements throughout the several views:

FIG. 1 is a cross-section through a first embodiment of a machine foot;

FIG. 2 shows the machine foot of FIG. 1 in a tilted position;

FIG. 3 shows a side view of the machine foot of FIGS. 1 and 2 in a position rotated by 90°;

FIG. 4 depicts schematically the engagement of a spherical surface with a conical surface;

FIG. 5 shows schematically the engagement of two super-positioned spherical surfaces;

FIG. 6 shows schematically the engagement of a spherical surface with a conical surface in the opposite arrangement of FIG. 4;

FIG. 7 is another embodiment of a machine foot with an elastomer sealing apron; and

FIG. 8 is another embodiment of an enclosed design of a machine foot with an integrated O-ring.

### DETAILED DESCRIPTION OF THE PRESENTLY PREFERRED EMBODIMENTS

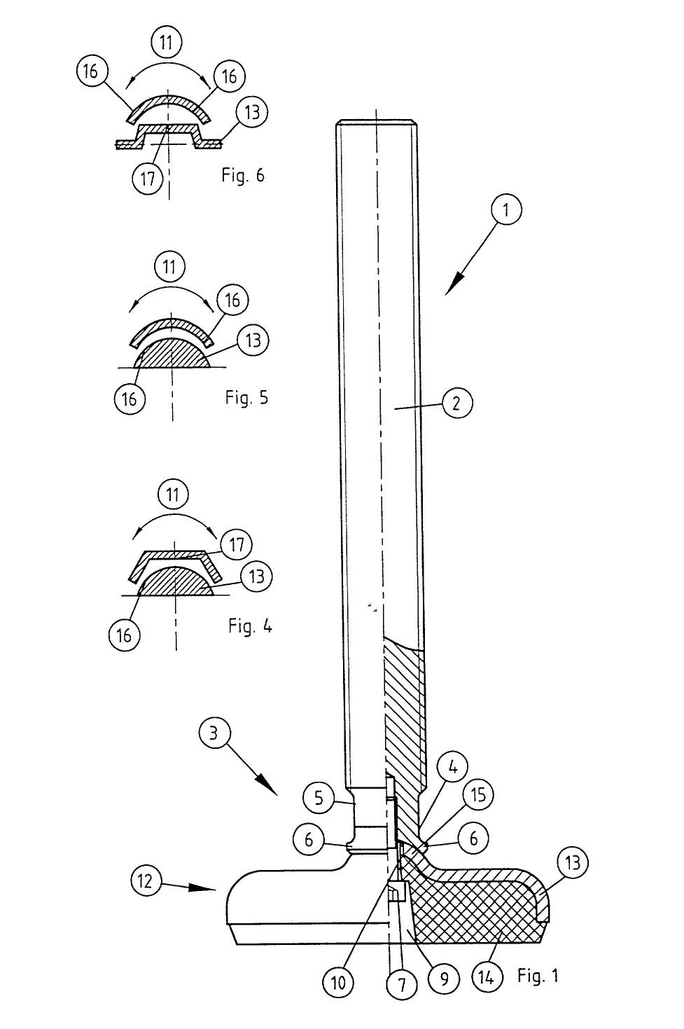

The machine foot 1 according to FIGS. 1 to 3 consists essentially of a threaded spindle 2 with a diameter of between approximately 5-30 mm.

A nut (not shown) which has an adjustable height on the threaded spindle 2 is disposed on the threaded spindle 2, with the nut supporting the machine load. The machine load is then transferred by the end of the threaded spindle 2 next to the floor to a support plate 12, wherein the interior space of the support plate can include an additional plate 14.

According to another embodiment, the plate 14 is vulcanized in the interior space of the support plate 14. For the vulcanizing process, the plate 14 is fitted tightly and sealed in the interior space of the support plate 12, since the vulcanizing process provides an absolutely tight seal.

This advantageously provides an absolutely tight seal against moisture entering from below.

In another embodiment, the center recess 9 can in addition be sealed by a sealing plug or by an elastomer sealing material, thereby protecting the center region against moisture incursion.

To provide a tight seal, it may indeed be sufficient to glue or vulcanize the rubber plate 14 sealingly with the inner circumference of the cover plate.

According to another embodiment, the plate 14 is made of metal instead of rubber, FIG. 8, so that the cover plate 13 and the metal plate 14 form a single element. Moreover, an annular groove 21 can be disposed on the bottom surface (support surface) of the metal plate, with an O-ring inserted into the metal groove.

The O-ring 20 is a circular O-ring which also provides an integral seal between the support surface of the plate 14 and the support surface.

This way, the entire bottom portion of the machine foot is protected against incursion of moisture and contaminants, as is the top portion as a result of the overlapping collars 6, 15.

In addition, a metal plate with a corresponding annular groove, into which a circular seal is inserted, can be substituted for the rubber plate 14.

However, the invention is not limited to this embodiment. The rubber plate 14 can also be omitted, and other supporting elements can be used instead of the rubber plate, such as plates, springs and the like.

Moreover, the entire support plate 12 can be constructed as a single solid piece. Depending on the characteristics of the floor, the supporting surface of the plate can be flat, pointed or have another form.

In the illustrated embodiment, the gap formed between the threaded spindle 2 and the support plate 12 which is to be sealed by the measures of the invention, is of particular interest.

The transition region 3 of this threaded spindle 2 has a thread undercut for separating the thread of the threaded spindle 2 from the transition region 3. The thread undercut 5, however, is not necessary for the present invention; according to another embodiment, the threaded region of the threaded spindle 2 can also extend to the side of the threaded spindle 2 facing the floor.

The transition region can also include a wrench flat 4 so that a suitable wrench can be used to rotate the entire threaded spindle 2 with respect to the stationary support plate.

Is important that the front end of the threaded spindle 2 has an outwardly extending annular collar 6, which annular collar overlaps a respective radially inwardly extending connecting collar 15 of the cover plate 13 of the support plate 12.

This forms two mutually overlapping surfaces which—according to FIGS. 4 to 6—can be in the form of spherical and/or conical surfaces.

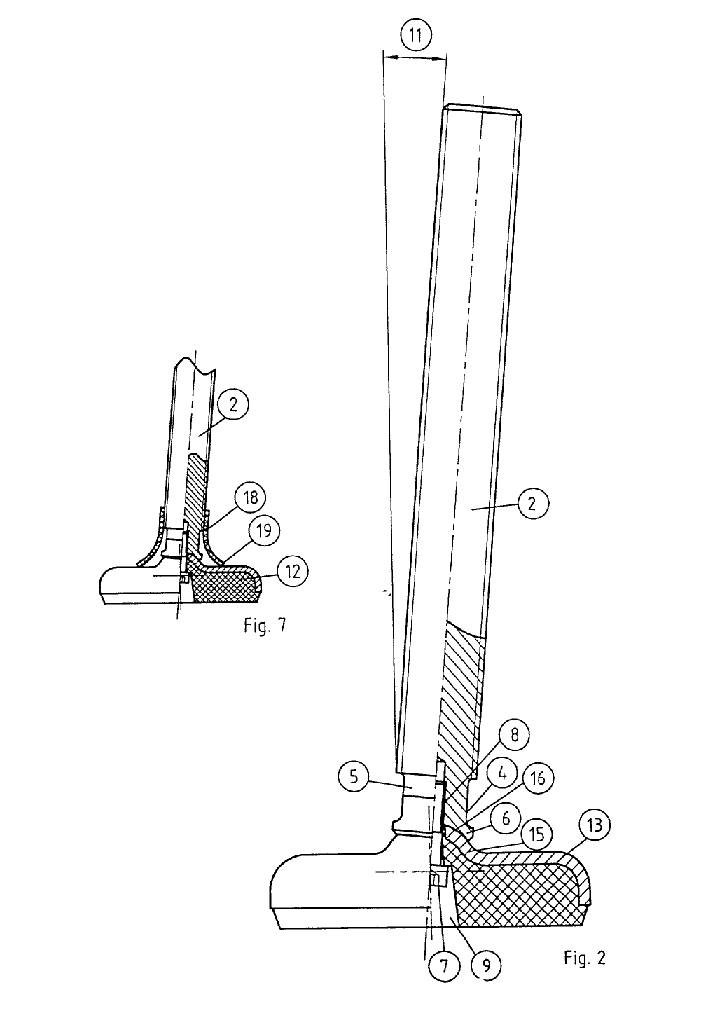

It is important that the outside circumference of the annular collar 6 is greater than the inner circumference of the connecting collar 15, so that these two elements overlap and form a sealing gap. The threaded spindle 2 can then still be tilted over the adjustment range 11 (see FIG. 2), without causing the liquid to come in contact with the threaded spindle and drip downwardly and reach the adjustment gap.

The threaded spindle 2 is also pivotally connected with the support plate 12. For this purpose, a fastening screw 7 is provided which engages with an approximately conical recess 9 disposed on the underside of the support plate and forms a gap 10 with respect to the corresponding surfaces of the support plate, thereby providing a certain adjustment clearance. The end of the fastening screw 7 facing the bolt engages with a threaded bore 8 disposed on the front end of the threaded spindle 2.

Various ways for mating the mutually corresponding surfaces are illustrated in FIGS. 4 to 6. As can be seen, not only matching spherical surfaces 16 can be mated, as illustrated in FIG. 5, but a conical surface 16 can also be mated with a corresponding opposing conical surface 17. It is important, that these surfaces 16, 17 transfer the load from the threaded spindle 2 to the support plate 12.

FIG. 4 shows another embodiment which is claimed separate from the aforedescribed embodiments, but can also be claimed in conjunction with these embodiments.

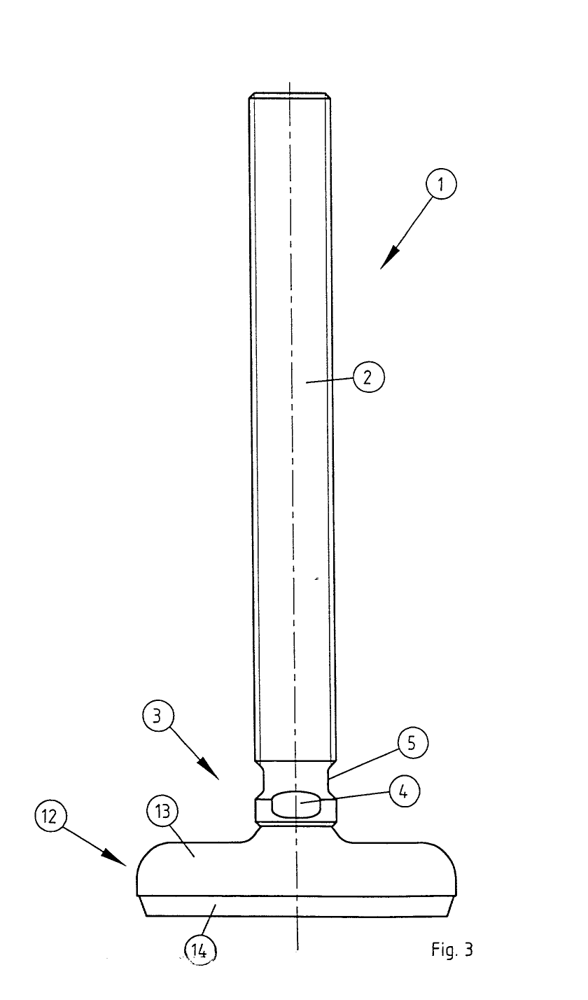

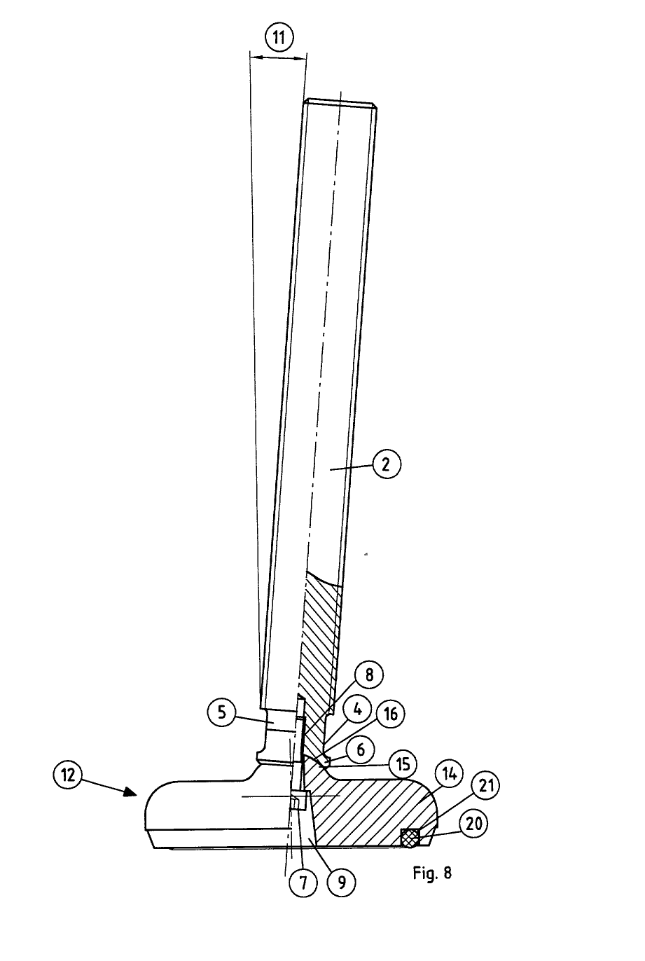

As illustrated, in this embodiment a sealing apron 18 can be provided, either in addition or alone (FIG. 7), which extends radially outwardly and sealingly contacts the threaded spindle 2. The sealing apron 18 is supported on the surface of the support plate 12 by a bottom sealingly lip 19.

This arrangement sealingly bridges the aforementioned adjustment gap between the threaded spindle 2 and the support plate 12. As described above, the sealing apron 18 can be used in combination with the embodiments shown in FIG. 1 to 3. In an alternative embodiment shown in FIG. 7, the sealing apron 18 can also be used without the overlapping elements 6, 15.

The invention is not limited to an embodiment where the annular collar 6 is connected as a single piece with the remaining elements of the threaded spindle 2. Two separate elements can also be provided. In this embodiment, for example, the annular collar 6 can have an interior thread which can be screwed on a corresponding threaded arbor of the threaded spindle 2.

It is also not necessary for the invention, that the support plate 12 includes a cover plate 13. The cover plate 13 can also be made of a solid material and thus form the entire support plate 12. The rubber plate 14 can then be either completely eliminated or implemented only as a rubber disk disposed on the bottom side of the support plate 12.

Moreover, a metal foot made of a solid material can be provided instead of the rubber plate 14, wherein the metal foot is then covered with a cover plate 13 which covers and seals the aforementioned adjustment gap.

FIG. 8 shows another embodiment of the present invention, wherein the plate 14 together with the cover plate is formed as a single unit 14. A circular annular groove 21, into which an O-ring is inserted, is provided on the bottom of this unit. The O-ring prevents contaminants and/or liquids from entering underneath the plate. Accordingly, unwanted liquids and/or contaminants cannot penetrate underneath the plate or enter the actual foot.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

What is claimed is:

1. A moveable machine foot with a sealing function, comprising
at least one element having an adjustable length portion,
an adjustable support element disposed on the at least one element for supporting the adjustable length portion; and
the machine being secured to the adjustable length portion; and
wherein the adjustable length portion has an annular collar on a side facing the support, with an outer diameter of the annular collar having a size sufficient for the annular collar covering and sealing against the connecting collar of the support plate even when the center axes of the two units are not mutually parallel, but are tilted at an angle.

2. The machine foot according to claim 1, wherein the adjustable length portion is a threaded spindle and the adjustable support element is a support plate.

3. The machine foot according to claim 2, wherein the annular collar covers the connecting collar to such an extent, that liquid does not contact the threaded spindle and does not drip downwardly and does not reaches the gap between the threaded spindle and the support plate.

4. The machine foot according to claim 2 , wherein an articulated joint is formed between the threaded spindle and the support plate facing a floor, and wherein a ball joint having a ball socket is formed.

5. The machine foot according to claim 2, wherein the threaded spindle has an end face with a concave surface facing the floor and the associated opposing surface on the support plate is convex, and the concave and the convex surfaces slide relative to one another and engage with one another, when the tilt of the support plate relative to the threaded spindle is adjusted.

6. The machine foot according to claim 2, wherein an articulated joint between the threaded spindle and the support plate (12).is formed by mating a spherical surface with an associated conical surface.

7. The machine foot according to claim 2, wherein two corresponding conical surfaces are mated for forming an articulated joint between the threaded spindle and the support plate.

8. The machine foot according to claim 2, wherein the threaded spindle is adjustably connected to the support plate with a fastening screw.

9. The machine foot according to claim 2, wherein an approximately conical recess engages with the underside of the support plate and forms a gap with respect to the respective surfaces of the support plate, providing an adjustment clearance.

10. The machine foot according to claims 2, wherein a plate is fitted in the interior space of the support plate so as to form a tight seal.

11. The machine foot according to claim 2, wherein the plate is vulcanized in the interior space of the support plate.

12. The machine foot according to claim 2, wherein the plate 14 includes a center recess which is closed off with a sealing plug or with an elastomer material.

13. The machine foot according to claim 11, wherein the plate is formed of rubber.

14. The machine foot according to claim 11, wherein the plate is formed of a metal.

15. The machine foot according to claim 11, wherein the cover plate and the plate form a single element.

16. The machine foot according to claim 15, wherein an annular groove is disposed on the contact surface of the plate.

17. The machine foot according to claims 16, wherein an O-ring is inserted into the annular groove.

18. A moveable machine foot with a sealing function comprising at least one element having a threaded spindle, with an adjustable support plate disposed on the threaded spindle for supporting the threaded spindle and the machine secured thereto with respect to a support surface or contact surface, wherein an elastomer sealing means is provided, with an upper annular collar of the elastomer sealing means sealingly contacting the threaded spindle, with radially outwardly extending surfaces of the elastomer sealing means overlapping the sealing gap between this threaded spindle and the support plate, and with corresponding sealing lips of the elastomer sealing means sealingly contacting the surface of the support plate.

19. The machine foot according to claim 18, wherein a spherical surface is mated with a corresponding opposing spherical or conical surface, and the spherical surface and the spherical or conical surface transfer of the load from the threaded spindle to the support plate.
